(19) United States
(12) Patent Application Publication
(10) Pub. No.: US 2007/0133830 A1
(43) Pub. Date: Jun. 14, 2007

(54) Low profile liquid sealed audio component assembly

(76) Inventors: Adema D. Verne, Pompano Beach, FL (US); David I. Blatt, Margate, FL (US); Bach L. Nguyen, Lauderhill, FL (US); Eduardo Nogueiras, Miramar, FL (US); Orrette Morris, Deerfield Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/300,059

(22) Filed: Dec. 14, 2005

(51) Int. Cl. H04R 5/02

(52) U.S. Cl. 381/308

(57) ABSTRACT

The invention concerns a low profile, liquid sealed audio component assembly (100). The assembly can include a seal (112) having an opening (114), a membrane (120) that can cover the opening and that can substantially block liquid from entering the seal and an audio component (122) contained within the seal and positioned outside a coverage area (C) underneath the membrane. The membrane can transfer acoustic signals to or from the audio component. In addition, the coverage area underneath the membrane can correspond to the area of the membrane that can receive acoustic signals. As an example, the audio component can be a microphone.

### BACKGROUND OF THE INVENTION

1. Field of the Invention

The present invention concerns mobile communications devices and more particularly, audio component assemblies of such devices.

2. Description of the Related Art

Manufacturers of mobile communications devices are constantly seeking ways to distinguish their products from one another. In recent years, reducing the thickness of mobile devices has become one way for manufacturers to do so. This crucial aspect has become paramount in handset design.

Another feature that consumers desire is to have their mobile communications devices include barriers to prevent water from seeping into the devices and damaging them. These devices, however, require one or more orifices to allow for communications to occur. For example, handsets include one or more microphones that include an opening in the housing of the handset that allows the microphone to capture acoustic signals. To prevent water from seeping into such an opening, it has been proposed to place a waterproof barrier over the microphone. The barrier allows a small amount of air to pass through it but blocks water or other liquids from doing so. As acoustic signals strike the barrier, the barrier will vibrate back and forth. To allow for this movement, there must be a considerable amount of space on either side of the barrier. This additional space requirement, however, adds to the thickness of the phone, which is a significant drawback.

### SUMMARY OF THE INVENTION

The present invention concerns a low profile, liquid sealed audio component assembly. The assembly can include a seal having an opening, a membrane that can cover the opening and that can substantially block liquid from entering the seal, and an audio component contained within the seal and positioned outside a coverage area underneath the membrane. The membrane can transfer acoustic signals to or from the audio component. In one arrangement, the coverage area underneath the membrane can correspond to the area of the membrane that receives acoustic signals. In addition, at least a portion of the audio component can be in the same horizontal plane as the membrane, and the audio component assembly can be located within a mobile communications device. As an example, the audio component can be a microphone.

In another arrangement, the seal can have a first section and a second section and a tunnel portion that can connect the first section to the second section. Additionally, the first section can include the opening and the membrane, and the second section can include the audio component. As an example, the tunnel portion can be designed to direct acoustic signals to the audio component when corresponding acoustic signals strike the membrane and cause the membrane to vibrate.

In yet another arrangement, the mobile communications device can include a housing and a substrate, and the housing, the substrate and the seal can form part of a sealed chamber. Also, the housing can include a grill positioned above the membrane, and the substrate can be positioned below the membrane. As an example, the distance between the grill and the substrate can be great enough to permit the membrane to vibrate back and forth without interference when acoustic signals of a predetermined range strike the membrane. As another example, the substrate can be a printed circuit board that can be electrically coupled to the audio component, and the membrane can be designed to allow at least some air to pass through the membrane.

The present invention also concerns a method of assembling a low profile, liquid sealed audio component assembly. The method can include the steps of positioning a seal against a substrate and a housing in which the seal can have a first chamber that can include an opening and a second chamber, placing a membrane over the opening of the first chamber in which the membrane can substantially block liquid from entering the first chamber and positioning an audio component in the second chamber. The audio component can be positioned such that the audio component can be located outside a coverage area underneath the membrane, and the membrane can transfer acoustic signals to or from the audio component.

As an example, the audio component assembly can be part of a mobile communications device, the audio component can be a microphone and the substrate can be a printed circuit board. Further, the housing can include a grill, and the method can also include the steps of positioning the grill above the membrane and positioning the substrate below the membrane. The distance between the grill and the substrate can be great enough to permit the membrane to vibrate back and forth without interference when acoustic signals of a predetermined range strike the membrane.

The present invention also concerns a method of porting acoustic signals to a microphone contained within a sealed chamber. The method can include the steps of receiving acoustic signals at a membrane that can cause the membrane to vibrate back and forth in which the membrane can cover an opening of the sealed chamber and can substantially block liquids from passing into the sealed chamber and transferring the acoustic signals to the microphone that is positioned outside a coverage area underneath the membrane.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates an audio component assembly in accordance with an embodiment of the inventive arrangements;

FIG. 2 is a cross-sectional view of the audio component assembly of FIG. 1 in accordance with an embodiment of the inventive arrangements; and

FIG. 3 illustrates the cross-sectional view of FIG. 2 superimposed on a housing of a mobile communications device in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically.

The present invention concerns a low profile, liquid-sealed audio component assembly. In one arrangement, the assembly can include a seal having an opening, a membrane that can cover the opening and that can substantially block liquid from entering the seal and an audio component contained within the seal and positioned outside a coverage area underneath the membrane. The membrane can transfer acoustic signals to or from the audio component. In addition, the coverage area underneath the membrane can correspond to the area of the membrane that receives acoustic signals, and at least a portion of the audio component can be in the same horizontal plane as the membrane.

As such, the invention presents an audio component assembly that can prevent liquids, such as water, from entering the housing of a mobile communications device. Because the audio component is positioned outside the coverage area of the membrane, however, the audio component and the membrane can be positioned substantially side-by-side, which can allow for proper operation of the membrane without adding to the thickness of the mobile device.

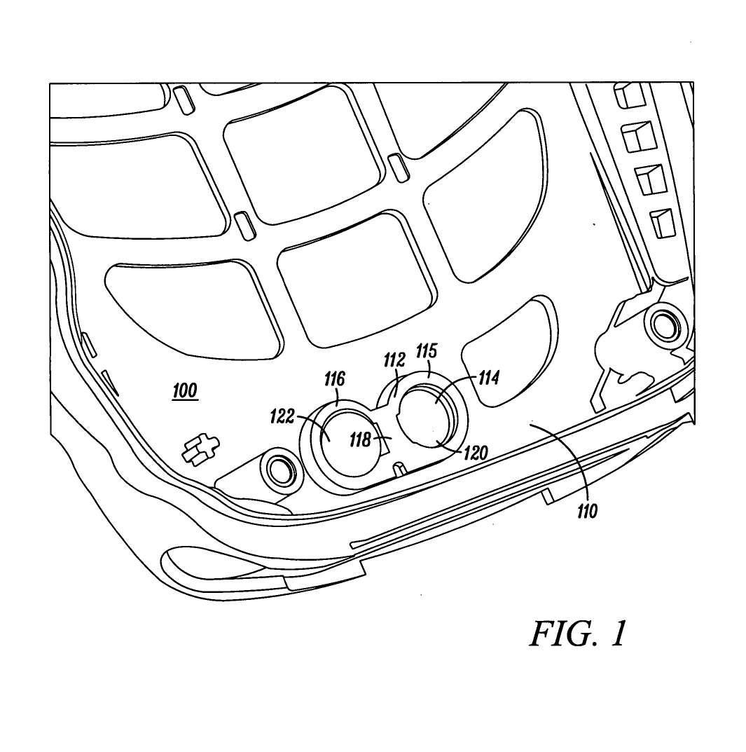

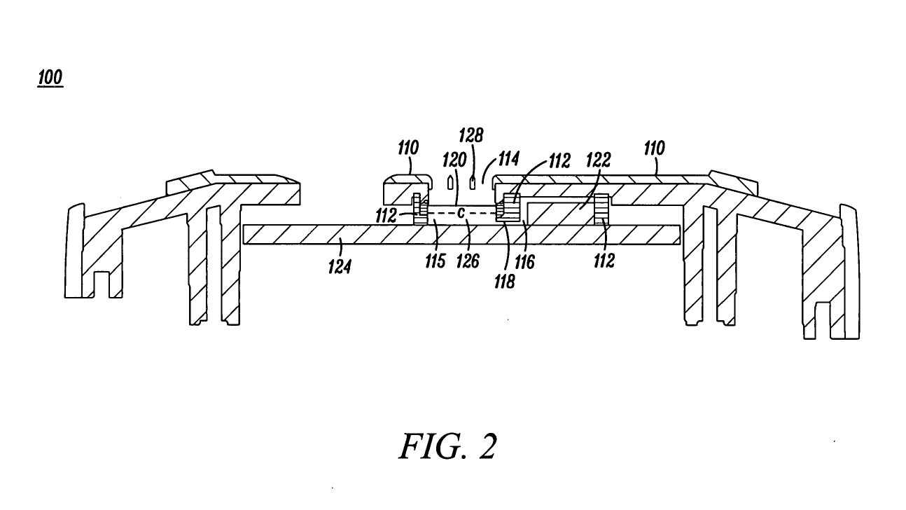

Referring to FIG. 1, an audio component assembly 100 is shown. The audio component assembly 100 can be part of a mobile communications device, and a housing 110 for this device is shown. It must be noted, however, that the assembly 100 is not limited to being incorporated in mobile devices, as the assembly 100 can be placed in any suitable communications device. Referring to FIG. 2, a cross-section of the assembly 100 is shown. Reference will be made to both FIGS. 1 and 2 when describing the invention.

In one arrangement, the assembly 100 can include a seal 112, which can include an opening 114 (best seen in FIG. 2), and the seal 112 can include a first section 115 and a second section 116. In addition, a tunnel portion 118 can connect the first section 115 and the second section 116. The opening 114 can be part of the first section 115, and a membrane 120 can cover the opening 114. As an example, the seal 112 can be made of any suitable material that is at least somewhat deformable and can provide an interference fit between two or more other components. As such, the membrane 120 can be secured to the seal 112 by any suitable adhesive.

In one arrangement, the membrane 120 can be constructed of any material that can substantially block liquid, such as water, from flowing through it. The membrane 120, however, can be permeable enough to permit some air to pass through it. As an example, the membrane 120 can be made of Gore-Tex expanded polytetrafluoroethylene (PTFE) manufactured by W.L. Gore & Associates, Inc. of Newark, Del. Of course, any other suitable material may be used here. As will be explained later, the membrane 120 can receive acoustic signals and can help transfer those signals to or even from an audio component 122. As an example, the audio component 122 may be a microphone, although the audio component 122 can be any other suitable device, such as a speaker. The term audio component can mean any component that is capable of producing or capturing any suitable form of an acoustic signal. For purposes of this description, the audio component 122 is to be referred to as microphone 122. Again, however, the invention is not limited to this particular example.

The second section 116 of the seal 112 can include the microphone 122, which can capture any suitable type of acoustic signals. In one embodiment, the microphone 122 can be positioned outside a coverage area C (see FIG. 2) underneath the membrane 120. As an example, the coverage area C can correspond to the area of the membrane 120 that can receive acoustic signals. As best seen in FIG. 2, because it is positioned outside the coverage area C and in the second section 116, the microphone 122 can be positioned substantially side-by-side with the membrane 120. In fact, at least a portion of the microphone 122 can be in the same horizontal plane as the membrane 120. In view of this configuration, the microphone 122 will not interfere with the membrane 120 as it vibrates back and forth when the membrane receives acoustic signals and can help reduce the thickness of any device containing the microphone assembly 100.

Referring to FIG. 2, the mobile communications device that can include the microphone assembly 100 can include a substrate 124 and the housing 110. The substrate 124 is not shown in FIG. 1 to enable the seal 112 and other components to be seen. The substrate 124 would normally be placed behind the seal 112 in FIG. 1 such that it follows along a vertical axis of the housing 110.

Focusing on FIG. 2 again, as an example, the substrate can be a printed circuit board (PCB) that can be electrically coupled to the microphone 122. When the seal 112 is positioned between the housing 110 and the substrate 124, the housing 110, the substrate 124, the seal 112 and the membrane 120 can form a sealed chamber 126. In view of this sealed chamber 126, the membrane 120 can transfer acoustic signals that it receives to the microphone 122. In particular, as those of skill in the art will appreciate, the membrane 120 can vibrate back and forth when acoustic signals strike its top surface, and this vibration can generate corresponding acoustic signals on the other side of the membrane 120 and inside the sealed chamber 126. In one arrangement, the tunnel portion 118 can help direct these acoustic signals to the microphone 122. Those of skill in the art will appreciate that this configuration can be used to transfer signals from an audio component 122, through the tunnel portion 118, through the membrane 120 and outside the housing 110.

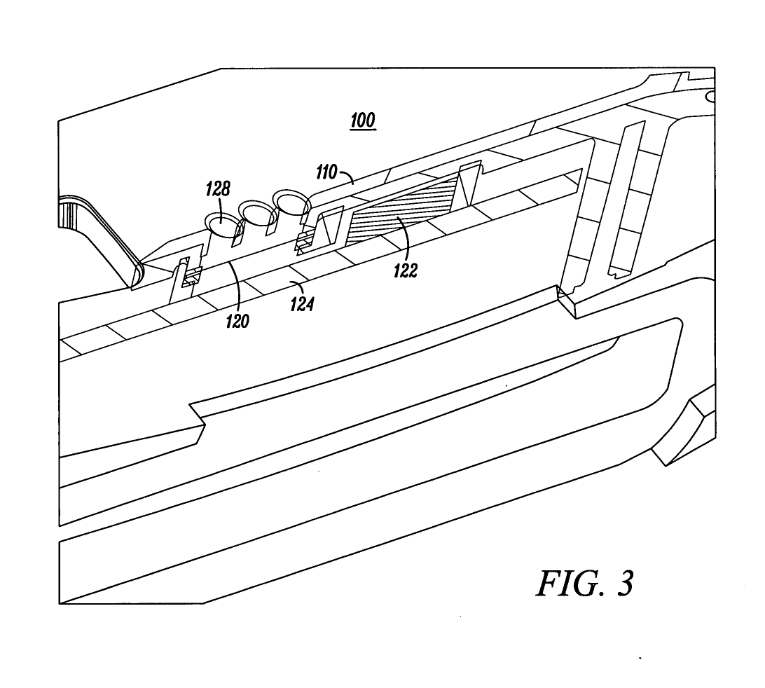

Referring to FIG. 3, a front view of the housing 110 of the mobile device that includes the microphone assembly 100 is shown. The cross-sectional view of FIG. 2 has been superimposed on FIG. 3. As can be seen, the housing 110 can include a grill 128 (see also FIG. 2) that can permit acoustic signals to pass through to the membrane 120 but can block relatively large objects from doing so (acoustic signals may also be emitted from the grill 128, if so desired). Referring to FIGS. 2 and 3, the grill 128 can be positioned above the membrane 120, and the substrate 124 can be positioned below the membrane 120. In one arrangement, the distance between the grill 128 and the substrate 124 can be great enough to permit the membrane 120 to vibrate back and forth without interference from the grill 128 or the substrate 124 when acoustic signals of a predetermined range strike the membrane 120. The predetermined range for the acoustic signals can refer to amplitude, frequency or any other characteristic of an acoustic signal that may cause the membrane 120 to vibrate back and forth or to vary the vibration of the membrane 120.

In view of the present invention, the microphone 122 can easily capture acoustic signals and can be protected from liquid intrusions without affecting the operation of the membrane 120. Also, if water or some other liquid were to come into contact with the membrane 120, the overall operation of the membrane 120 should not be substantially affected in view of its liquid-proof construction. As such, the performance of the microphone 122 should not be substantially affected. It is important to note, however, that although described primarily in terms of a microphone, the invention is not limited as such. The invention will work for any other suitable audio component, including a speaker.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A low profile, liquid sealed audio component assembly, comprising:
a seal having an opening;
a membrane that covers the opening and that substantially blocks liquid from entering the seal; and
an audio component contained within the seal and positioned outside a coverage area underneath the membrane, wherein the membrane transfers acoustic signals to or from the audio component.

2. The assembly according to claim 1, wherein the coverage area underneath the membrane corresponds to the area of the membrane that receives acoustic signals.

3. The assembly according to claim 1, wherein at least a portion of the audio component is in the same horizontal plane as the membrane.

4. The assembly according to claim 1, wherein the audio component assembly is located within a mobile communications device.

5. The assembly according to claim 1, wherein the seal has a first section and a second section and a tunnel portion that connects the first section to the second section.

6. The assembly according to claim 5, wherein the first section includes the opening and the membrane and the second section includes the audio component.

7. The assembly according to claim 5, wherein the tunnel portion is designed to direct acoustic signals to the audio component when corresponding acoustic signals strike the membrane and cause the membrane to vibrate.

8. The assembly according to claim 4, wherein the mobile communications device includes a housing and a substrate and the housing, the substrate and the seal form part of a sealed chamber.

9. The assembly according to claim 8, wherein the housing includes a grill positioned above the membrane and the substrate is positioned below the membrane, wherein the distance between the grill and the substrate is great enough to permit the membrane to vibrate back and forth without interference when acoustic signals of a predetermined range strike the membrane.

10. The assembly according to claim 8, wherein the substrate is a printed circuit board that is electrically coupled to the audio component.

11. The assembly according to claim 1, wherein the membrane is designed to allow at least some air to pass through the membrane.

12. The assembly according to claim 1, wherein the audio component is a microphone.

13. A low profile, liquid sealed audio component assembly, comprising:
a seal having an opening;
a membrane that covers the opening and that substantially blocks liquid from entering the seal; and
an audio component contained within the seal and positioned such that at least a portion of the audio component is in the same horizontal plane as the membrane, wherein the membrane transfers acoustic signals to or from the audio component.

14. The assembly according to claim 13, wherein the assembly is part of a mobile communications device that includes a housing and a substrate and the housing, the substrate and the seal form part of a sealed chamber.

15. The assembly according to claim 13, wherein the audio component is a microphone.

16. A method of assembling a low profile, liquid sealed audio component assembly, comprising:
positioning a seal against a substrate and a housing, wherein the seal has a first chamber that includes an opening and a second chamber;
placing a membrane over the opening of the first chamber, wherein the membrane substantially blocks liquid from entering the first chamber; and
positioning an audio component in the second chamber such that the audio component is located outside a coverage area underneath the membrane, wherein the membrane transfers acoustic signals to or from the audio component.

17. The method according to claim 16, wherein the audio component assembly is part of a mobile communications device and the substrate is a printed circuit board.

18. The method according to claim 16, wherein the housing includes a grill and the method further comprises positioning the grill above the membrane and positioning the substrate below the membrane such that the distance between the grill and the substrate is great enough to permit the membrane to vibrate back and forth without interference when acoustic signals of a predetermined range strike the membrane.

19. The method according to claim 16, wherein the audio component is a microphone.

20. A method of porting acoustic signals to a microphone contained within a sealed chamber, comprising:
receiving acoustic signals at a membrane that cause the membrane to vibrate back and forth, wherein the membrane covers an opening of the sealed chamber and substantially blocks liquids from passing into the sealed chamber; and
transferring the acoustic signals to the microphone that is positioned outside a coverage area underneath the membrane.
